(19) United States
(12) Patent Application Publication
(10) Pub. No.: US 2025/0042347 A1
(43) Pub. Date: Feb. 6, 2025

(54) WIRE MOVABLE PATH REGULATING COMPONENT AND PATH REGULATING WIRE HARNESS

(71) Applicant: SUMITOMO WIRING SYSTEMS, LTD., Yokkaichi-shi, Mie (JP)

(72) Inventors: Kazuma ISODA, Yokkaichi-shi (JP); Hiroki UNO, Yokkaichi-shi (JP)

(73) Assignee: SUMITOMO WIRING SYSTEMS, LTD., Yokkaichi-shi, Mie (JP)

(21) Appl. No.: 18/847,782

(22) PCT Filed: Mar. 9, 2023
(86) PCT No.: PCT/JP2023/009073

§ 371 Date: Sep. 17, 2024

(30) Foreign Application Priority Data
Mar. 30, 2022 (JP) 2022-055489

(51) Int. Cl. B60R 16/02; H02G 3/04

(52) U.S. Cl. CPC B60R 16/0215; H02G 3/04

(57) ABSTRACT

A wire movable path regulating component for regulating a movable path of at least one first wire and at least one second wire that extend between a first component and a second component movable relative to the first component, the wire movable path regulating component including: a main body configured to be coupled in a rotationally movable manner to another wire movable path regulating component; and a cover that is a separate component from the main body and is attached to the main body.

### BACKGROUND

The present disclosure relates to a wire movable path regulating component and a path regulating wire harness.

JP 2020-141519A discloses a cable guide in which a plurality of tubular link frame bodies disposed in a row are coupled together in such a manner as to be rotatable relative to each other. The link frame bodies each include a main body part and a cover body and are constituted to be tubular in shape. A wire harness is housed in the coupled link frame bodies.

### SUMMARY

For example, the link frame bodies themselves are assumed to be designed in accordance with a basic design for wiring in a vehicle. However, electrical wires may possibly be added after the basic design. It is thus desired to be able to readily handle the case where electrical wires are added to the basic design.

An exemplary aspect of the disclosure is to be able to readily handle addition of electrical wires.

A wire movable path regulating component of the present disclosure is a wire movable path regulating component for regulating a movable path of at least one first wire and at least one second wire that extend between a first component and a second component movable relative to the first component, the wire movable path regulating component including: a main body configured to be coupled in a rotationally movable manner to another wire movable path regulating component; and a cover that is a separate component from the main body and is attached to the main body, wherein: the main body has a housing opening through which the at least one first wire is to be housed and a first wire housing space configured to house the at least one first wire in a state of passing therethrough inside the housing opening, the cover has a cover main body that blocks the housing opening and an additional enclosing part forming a second wire housing space configured to house the at least one second wire in a state of passing therethrough, and the second wire housing space is partitioned from the first wire housing space by the cover main body.

Also, a path regulating wire harness of the present disclosure is a path regulating wire harness including a plurality of the wire movable path regulating component, the at least one first wire, and the at least one second wire, the plurality of wire movable path regulating components being coupled together in a row in such a manner as to be rotationally movable relative to each other, the at least one first wire being housed in the plurality of wire movable path regulating components in a state of passing through the first wire housing space, and the at least one second wire being housed in the plurality of wire movable path regulating components in a state of passing through the second wire housing space.

According to the present disclosure, addition of electrical wires can be readily handled.

### BRIEF DESCRIPTION OF THE DRAWINGS

FIG. 1 is a schematic plan view showing a state in which a path regulating wire harness according to an embodiment is arranged between a vehicle body main body and a sliding door.

FIG. 2 is a perspective view showing part of the path regulating wire harness.

FIG. 3 is a cross-sectional view taken along line III-III in FIG. 2.

FIG. 4 is an exploded perspective view showing a wire movable path regulating component.

FIG. 5 is a cross-sectional view taken along line V-V in FIG. 2 showing the wire movable path regulating component.

### DETAILED DESCRIPTION OF EMBODIMENTS

### Description of Embodiments of Disclosure

Initially, modes of the present disclosure will be enumerated and described.

A wire movable path regulating component of the present disclosure is as follows.

(1) A wire movable path regulating component for regulating a movable path of at least one first wire and at least one second wire that extend between a first component and a second component movable relative to the first component, including a main body component to be coupled in a rotationally movable manner to another wire movable path regulating component, and a cover component that is a separate component from the main body component and is attached to the main body component, the main body component having a housing opening through which the at least one first wire is housed and a first wire housing space for housing the at least one first wire in a state of passing therethrough inside the housing opening, the cover component having a cover main body part that blocks the housing opening and an additional enclosing part forming a second wire housing space for housing the at least one second wire in a state of passing therethrough, and the second wire housing space being partitioned from the first wire housing space by the cover main body part.

According to this wire movable path regulating component, even if the second wire is added, the path of the first wire which is based on a basic design is regulated within the first wire housing space. The addition of the second wire is thus unlikely to affect the movement of the first wire. Also, the path of the second wire is regulated within the second wire housing space partitioned from the first wire housing space. The path of the first wire is regulated within the first wire housing space, and, separately thereto, the path of the second wire is regulated within the second wire housing space. Changes in the path lengths of the first wire and the second wire in response to changes in the paths thereof are thus reduced. Variation in the loads acting on the first wire and the second wire is thereby reduced, when the paths of the first wire and the second wire change.

(2) The wire movable path regulating component according to (1), the at least one second wire housed within the second wire housing space may be fewer in number than the at least one first wire housed within the first wire housing space. In this case, the smaller number of second wires can be readily added.

(3) The wire movable path regulating component according to (1) or (2), the main body component may have a locking part located on both side portions of the housing opening, the cover main body part may have a lock-receiving part to which the locking part is latched, and the additional enclosing part may be located inward of the lock-receiving part. The lock-receiving part can thereby be readily molded.

(4) The wire movable path regulating component according to any one of (1) to (3), the cover component may have regulating shape plane symmetry with respect to a surface orthogonal to a width direction and regulating shape plane symmetry with respect to a surface orthogonal to a through direction of the second wire housing space. Since the cover component can be attached to the main body component without worrying about orientation, the ease of assembling the wire movable path regulating component is thereby improved.

(5) The wire movable path regulating component according to any one of (1) to (4), a length of the additional enclosing part in the through direction of the second wire housing space may gradually decrease proceeding away from the main body component. When the wire movable path regulating component rotates relative to another wire movable path regulating component, the additional enclosing part is thereby unlikely to interfere with the other wire movable path regulating component.

(6) The wire movable path regulating component according to any one of (1) to (5), a portion of the additional enclosing part on an opposite side to the main body component may be formed in an arc shape as viewed in the through direction of the second wire housing space. In this way, when the portion of the additional enclosing part on the opposite side to the main body component has an arc shape, it is easy to cover the wire movable path regulating component with an exterior component such as a rubber boot.

Also, a path regulating wire harness according to the present disclosure is as follows.

(7) A path regulating wire harness including a plurality of the wire movable path regulating component according to any one of (1) to (6), the at least one first wire, and the at least one second wire, the plurality of wire movable path regulating components being coupled together in a row in such a manner as to be rotationally movable relative to each other, the at least one first wire being housed in the plurality of wire movable path regulating components in a state of passing through the first wire housing space, and the at least one second wire being housed in the plurality of wire movable path regulating components in a state of passing through the second wire housing space.

Addition of electrical wires can thereby be readily handled, and, in the path regulating wire harness, variation in the loads acting on the first wire and the second wire is reduced, when the paths of the first wire and the second wire change.

### Detailed Description of Embodiments of Disclosure

Specific examples of a wire movable path regulating component and a path regulating wire harness of the present disclosure will be described below with reference to the drawings. Note that the present disclosure is not limited to these illustrative examples and is indicated by the claims, and all changes that come within the meaning and range of equivalency of the claims are intended to be embraced therein.

### Embodiment

Hereinafter, a wire movable path regulating component and a path regulating wire harness according to an embodiment will be described.

### Example Application of Path Regulating Wire Harness

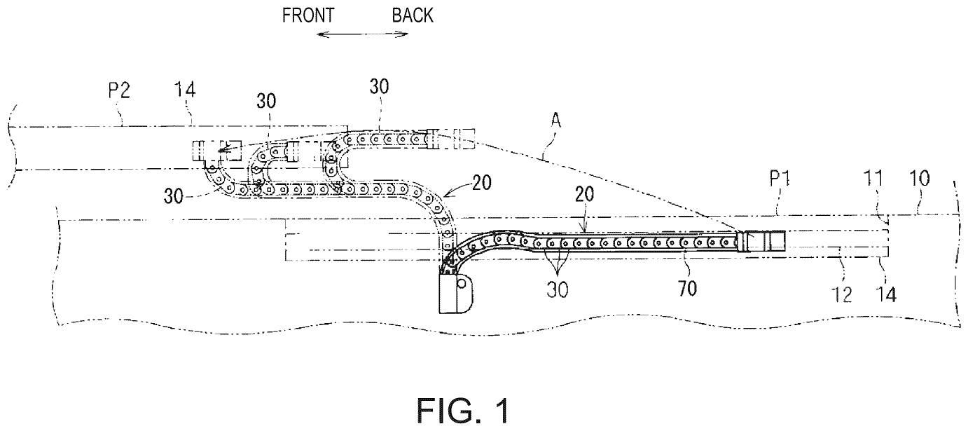

FIG. 1 is a schematic plan view showing a state in which a path regulating wire harness 20 is arranged between a vehicle body main body 10 and a sliding door 14. Note that, in FIG. 1, the path along which the sliding door 14 moves when the sliding door 14 is opened and closed is indicated by an arrow A. Also, the change in the state of the path regulating wire harness 20 with opening and closing of the sliding door 14 is indicated by a two-dot chain line.

The relationship between the vehicle body main body 10 and the sliding door 14 will now be described. A vehicle includes the vehicle body main body 10 and the sliding door 14 provided on one side portion of the vehicle body main body 10. A passenger entrance 11 through which people can get in and out of the vehicle is provided on the one side portion of the vehicle body main body 10. The sliding door 14 is supported in such a manner as to be movable between a position at which the passenger entrance 11 is closed (closed position P1) and a position at which the passenger entrance 11 is open (open position P2), by a slide support mechanism part that includes a guide rail 12 and a movable support part that supports the sliding door 14 in a state of being movable along the guide rail 12. In the present embodiment, the closed position P1 is located rearward of the open position P2.

The sliding door 14 opens and closes the passenger entrance 11 by sliding on the side of the vehicle body main body 10. Here, the sliding door 14 displaces outward in the vehicle width direction (see arrow A) while sliding from the closed position P1 to the open position P2. The vehicle body main body 10 is an example of a first component, and the sliding door 14 is an example of a second component that moves relative to the vehicle body main body 10.

The path regulating wire harness 20 extends between a vehicle body main body 10 and a sliding door 14 such as described above. When the sliding door 14 moves relative to the vehicle body main body 10, the path regulating wire harness 20 moves with the movement of the sliding door 14. The range of movement of the path at this time is regulated by a wire movable path regulating component 30. Interference of the path regulating wire harness 20 with the sliding door 14 or a peripheral portion of the passenger entrance 11 of the vehicle body main body 10 is thereby suppressed.

The first component and the second component between which the path regulating wire harness 20 extends are not limited to the above examples. The path regulating wire harness 20 extends between a first component and a second component that moves relative to the first component. For example, the first component may be a vehicle body (e.g., floor) and the second component may be a sliding seat.

### Regarding Path Regulating Wire Harness

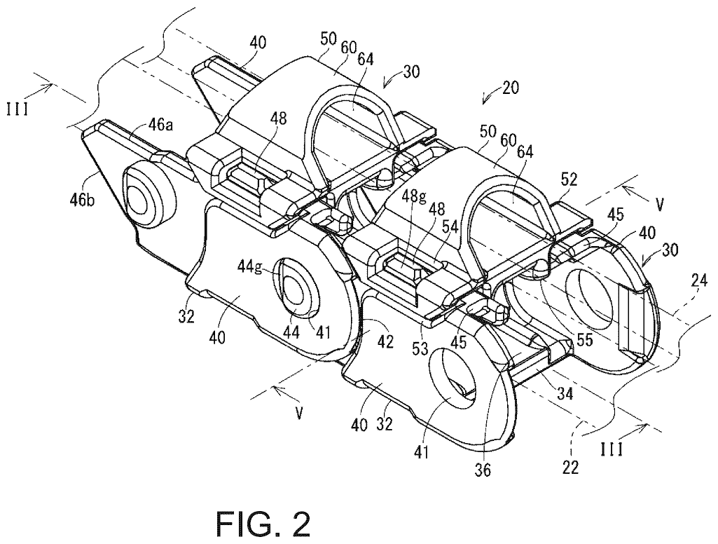

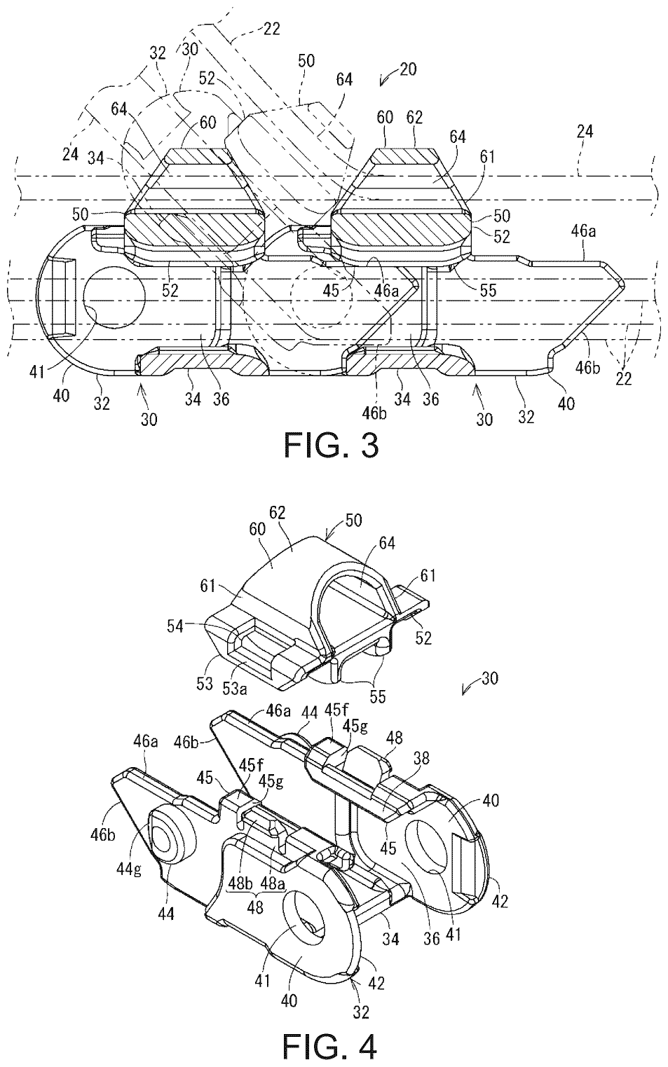

FIG. 2 is a perspective view showing part of the path regulating wire harness 20, and FIG. 3 is a cross-sectional view taken along line III-III in FIG. 2. In FIG. 3, a state in which wire movable path regulating components 30 that are coupled together move rotationally is indicated by two-dot chain lines.

As shown in FIGS. 1 to 3, the path regulating wire harness 20 is provided with a plurality of wire movable path regulating components 30, at least one first wire 22, and at least one second wire 24. A plurality of first wires 22 are shown as one bundle in FIG. 2.

The plurality of wire movable path regulating components 30 are coupled together in a row in such a manner as to be rotationally movable relative to each other. In the present embodiment, adjacent wire movable path regulating components 30 are coupled together in such a manner as to be rotationally movable about one axis. The adjacent wire movable path regulating components 30 are thus restricted from rotationally moving about a different axis from the one axis. As a result of the plurality of wire movable path regulating components 30 being coupled in such a manner as to be rotationally movable about axes parallel to the one axis, the plurality of wire movable path regulating components 30 are coupled so as to be able to bend in one plane, and bending in a direction away from the one plane is inhibited.

Also, the rotational movement range of the adjacent wire movable path regulating components 30 about the one axis is regulated. The bending direction and bending range of the plurality of wire movable path regulating components 30 are thereby regulated in the one plane. The configuration for regulating this rotational movement range will be described later.

The wire movable path regulating components 30 each include a first wire housing space 36 and a second wire housing space 64. The first wire housing space 36 and the second wire housing space 64 are adjacent to each other in a partitioned state.

The first wire 22 is a wiring member that electrically connects an electrical component on the vehicle body main body 10 side with an electrical component on the sliding door 14 side. One first wire 22 or a plurality of first wires 22 may be provided. The second wire 24 is a wiring member that electrically connects an electrical component on the vehicle body main body 10 side with an electrical component on the sliding door 14 side. One second wire 24 or a plurality of second wires 24 may be provided. The first wire 22 has, for example, a core wire 22a and an insulating coating 22b that covers the core wire 22a. The second wire 24 includes, for example, a core wire 24a and an insulating coating 24b that covers the core wire 24a.

The first wire 22 is, for example, envisaged to be a wiring material for connecting installed electrical components at the basic design stage of a vehicle. The second wire 24 is, for example, envisaged to be a wiring material that is connected to an electrical component added due to retrofitting or the like after the basic design stage of the vehicle. The number of second wires 24 is thus envisaged to be fewer than the number of first wires 22.

The first wire 22 is passed through and housed in the respective first wire housing spaces 36 of the plurality of wire movable path regulating components 30 that are arranged successively in a row. The second wire 24 is passed through and housed in the respective second wire housing spaces 64 of the plurality of wire movable path regulating components 30 that are arranged successively in a row. The paths of the first wire 22 and the second wire 24 are thus regulated within the separate spaces 36 and 64 of the plurality of wire movable path regulating components 30, while remaining in parallel.

The first wire 22 and the second wire 24 may be signal cables or power cables. A plurality of first wires 22 may be bundled in the form of a twisted wire or may be bundled in a state of being covered by a sheath. Similarly, a plurality of second wires 24 may be bundled by being twisted together or covered with a sheath. The first wire 22 and the second wire 24 may also include a coaxial cable.

### Regarding Wire Movable Path Regulating Component

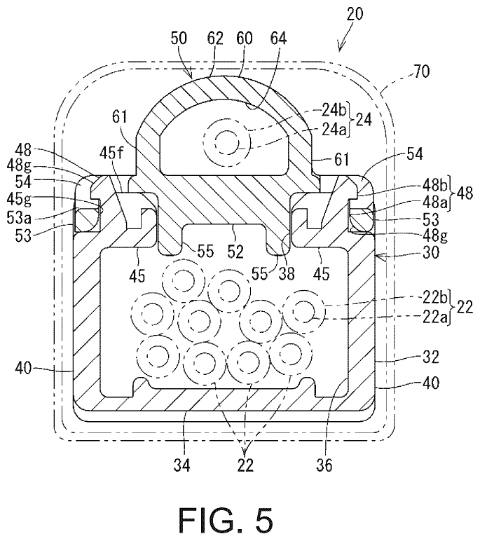

The wire movable path regulating component 30 will now be described. FIG. 4 is an exploded perspective view showing the wire movable path regulating component 30. FIG. 5 is taken along line V-V in FIG. 2 showing the wire movable path regulating component 30.

The wire movable path regulating component 30 is provided with a main body component 32 (main body) and a cover component 50 (cover). The main body component 32 and the cover component 50 are, for example, components that are separately molded from resin.

The main body component 32 is coupled in a rotationally movable manner to the main body component 32 of another wire movable path regulating component 30. The main body component 32 has a housing opening 38 and the first wire housing space 36. The housing opening 38 is an opening through which the first wire 22 is housed within the main body component 32. The first wire housing space 36 is a space for housing the first wire 22 in a state of passing therethrough inside the housing opening 38.

More specifically, the main body component 32 is a component integrally molded from resin and is provided with a bottom piece 34 and a pair of side pieces 40.

The side pieces 40 are formed in an elongated plate shape. A coupling recessed part 41 is formed at one longitudinal end portion of each side piece 40. In the present embodiment, the coupling recessed part 41 is a round through hole. The outer peripheral edge of the one longitudinal end portion of each side piece 40 is formed as an arc-shaped edge 42 that projects outward.

A coupling protruding part 44 is formed on the outward-facing surface of the other longitudinal end portion of each side piece 40. In the present embodiment, the coupling protruding part 44 is a short cylindrical protrusion. The coupling protruding parts 44 of the other longitudinal end portions of the pair of side pieces 40 are fitted into the coupling recessed parts 41 of the one longitudinal end portions of another pair of side pieces 40. A plurality of adjacent main body components 32 are thereby coupled in such a manner as to be rotationally movable about a central axis of the pair of coupling protruding parts 44.

A portion of the distal end surface of the coupling protruding part 44 toward the other longitudinal end portion of each side piece 40 is formed as a guide surface 44g that reduces the protruding length proceeding toward the other longitudinal end portion of the side piece 40. The one end portion of each side piece 40 can thus readily ride up onto the coupling protruding part 44 of another side piece 40, utilizing the guide surface 44g of the coupling protruding part 44. The coupling protruding part 44 can thereby be readily fitted into the coupling recessed part 41.

The outward-facing surface of the other longitudinal end portion of each side piece 40 is more recessed than the outward-facing surface of the one longitudinal end portion of the side piece 40. The difference in level between outer surface of the one end portion of one side piece 40 and the outer surface of one end portion of another side piece 40 can thereby be reduced, in a state where the other end portion of the one side piece 40 is overlapped with the outer surface of the one end portion of the other side piece 40.

The outer peripheral edge of the other longitudinal end portion of each side piece 40 is formed in a shape that regulates the rotational movement range relative to another side piece 40. In the present embodiment, the outer peripheral edge of the other longitudinal end portion of the side piece 40 has a first regulating edge 46a that extends in the longitudinal direction of the side piece 40 and a second regulating edge 46b that inclines relative to the longitudinal direction of the side piece 40. The first regulating edge 46a and the second regulating edge 46b face in opposite directions to each other.

Two side pieces 40 are coupled together as a result of the coupling protruding part 44 being fitted into the coupling recessed part 41. In a state where the two side pieces 40 extend in a straight line, the first regulating edge 46a of one side piece 40 contacts an inward-facing protruding part 45 of the other side piece 40 (state indicated by a solid line in FIG. 3). In a state where the two side pieces 40 have rotationally moved relative to each other, the second regulating edge 46b of the one side piece 40 contacts the bottom piece 34 of the other side piece 40 (state indicated by a two-dot chain line in FIG. 3). The rotational movement range of the two side pieces 40 is thus restricted to the range over which the two regulating edges 46a and 46b of the one side piece 40 contact the inward-facing protruding part 45 or the bottom piece 34 of the other side piece 40.

The shapes of the first regulating edge 46a and the second regulating edge 46b are set as appropriate, according to the rotational movement range required between adjacent side pieces 40.

The bottom piece 34 is coupled to one side edge of each of the pair of side pieces 40. The first wire housing space 36 is the space enclosed by the bottom piece 34 and the pair of side pieces 40. The first wire housing space 36 is open on both longitudinal sides of the side pieces 40. The direction in which the first wire 22 passes through the two openings of the first wire housing space 36 is a through direction of the first wire housing space 36. This through direction coincides with the longitudinal direction of the side pieces 40. The first wire 22 can be housed in a state of passing through the first wire housing space 36 in such as manner as to extend on both longitudinal sides of the side pieces 40. The first wire housing space 36 is also open on the opposite side to the bottom piece 34. This opening is the housing opening 38 through which the first wire 22 is housed. The first wire housing space 36 is located on the bottom piece 34 side of the housing opening 38, that is, inside the housing opening 38. The first wire 22 is housed in a state of passing through the first wire housing space 36 via the housing opening 38.

The inward-facing protruding part 45 protruding toward the widthwise center of the pair of side pieces 40 is formed on the other side edge of each of the pair of side pieces 40. The inward-facing protruding part 45 is formed in a longitudinally intermediate portion of the other side edge of each of the pair of side pieces 40. There is a gap between distal end portions of the pair of inward-facing protruding parts 45. The gap is set to a size that allows the first wire 22 to pass through.

The first regulating edges 46a are able to contact the inward-facing protruding parts 45. The surfaces of the inward-facing protruding parts 45 on the opposite side to the bottom piece 34 are formed on support surfaces 45f that extend in the longitudinal direction of the side pieces 40 and in a direction orthogonal to the side pieces 40. The cover component 50 is stably supported on the support surfaces 45f.

The main body component 32 has a lock protruding part 48 as a locking part located on both side portions of the housing opening 38. Here, a long hole part 45g is formed in the longitudinal direction of each side piece 40 in a longitudinally intermediate portion of the inward-facing protruding part 45. The lock protruding part 48 serving as a locking part protrudes through the hole part 45g from the other side edge of the side piece 40. The lock protruding part 48 has a plate part 48a that protrudes outward in the width direction of the side piece 40 and a protruding part 48b that protrudes in the thickness direction of the plate part 48a from a distal end portion of the plate part 48a. The plate part 48a is formed at an interval to the inner peripheral surface of the hole part 45g and can elastically deform within the hole part 45g. The protruding parts 48b protrude outward of the pair of side pieces 40. The distal end portion of each protruding part 48b is formed as a guide surface 48g that gradually decreases in height toward the distal end portion of the plate part 48a.

The cover component 50 is integrally molded from resin, separately from the main body component 32. The cover component 50 has a cover main body part 52 (cover main body) and an additional enclosing part 60.

The cover main body part 52 includes a plate-shaped portion that blocks the housing opening 38. The cover main body part 52 is not required to block the entire housing opening 38 and need only block the housing opening 38 to the extent that the first wire 22 is prevented from coming out through the housing opening 38. In the present embodiment, the cover main body part 52 blocks the portion of the housing opening 38 where the inward-facing protruding parts 45 are provided.

More specifically, the cover main body part 52 includes a rectangular plate-shaped portion. The width of the cover main body part 52 is set to be larger than the interval between the pair of side pieces 40. The length of the cover main body part 52 is set to be long enough to be able to cover the inward-facing protruding parts 45. The cover main body part 52 is able to cover the housing opening 38, when placed on the support surfaces 45f of the pair of inward-facing protruding parts 45.

The cover main body part 52 has a positioning auxiliary protruding part 53 that extends over the outward-facing surface of the other side edge of each of the pair of side pieces 40. Positioning of the cover main body part 52 in the width direction is performed as a result of the pair of positioning auxiliary protruding parts 53 contacting the outward-facing surfaces of the pair of side pieces 40 in a state where the cover main body part 52 is blocking the housing opening 38.

The cover main body part 52 has locking hole parts 54 as lock-receiving parts that the lock protruding parts 48 latch to. In the present embodiment, the locking hole parts 54 are formed in corner portions of the cover main body part 52 that extend from the portions that are placed on the support surfaces 45f to the positioning auxiliary protruding parts 53. Edge portions 53a of the locking hole parts 54 formed in the positioning auxiliary protruding parts 53 face in the protruding direction of the lock protruding parts 48. The cover main body part 52 is thus locked so as to not separate from the other side edges of the side pieces 40, as a result of the protruding parts 48b of the lock protruding parts 48 latching to the edge portions 53a.

The locking hole parts 54 also extend to the portions of the cover main body part 52 that are placed on the support surfaces 45f. The lock protruding parts 48 are able to elastically deform in the thickness direction of the plate parts 48a, utilizing the portions of the locking hole parts 54 that extend over the support surfaces 45f.

The cover component 50 is attached to the main body component 32, as a result of the pair of lock protruding parts 48 latching to the pair of locking hole parts 54 in a retained manner. Note that locking hole parts may be formed in the main body component, and lock protruding parts may be formed on the cover component.

The cover main body part 52 has a pair of auxiliary pieces 55 that extend toward the bottom piece 34, inward of the distal end portions of the inward-facing protruding parts 45. Looseness of the cover main body part 52 with respect to the main body component 32 is suppressed, as a result of the pair of auxiliary pieces 55 contacting the distal end portions of the inward-facing protruding parts 45, in a state where the cover component 50 is attached to the main body component 32.

The additional enclosing part 60 is a portion that forms the second wire housing space 64 for housing the second wire 24 in a state of passing therethrough. The second wire housing space 64 is a space partitioned from the first wire housing space 36 by the cover main body part 52.

In the present embodiment, the additional enclosing part 60 has a pair of base end portions 61 and an enclosing main body part 62.

The pair of base end portions 61 are located inward of the pair of locking hole parts 54. The pair of base end portions 61 have a long plate shape in the longitudinal direction of the side pieces 40 and protrude on the opposite side to the main body component 32 with respect to the cover main body part 52.

The enclosing main body part 62 joins the distal end portions of the pair of base end portions 61 at a position spaced away from the cover main body part 52. In the present embodiment, the enclosing main body part 62 is formed in a plate shape that describes an arc projecting on the opposite side to the bottom piece 34, as viewed in the longitudinal direction of the side pieces 40. Therefore, in the present embodiment, the additional enclosing part 60 has a U-shape in which the pair of base end portions 61 are continuous with both end portions of the enclosing main body part 62, as viewed in the longitudinal direction of the side pieces 40.

Since the pair of base end portions 61 are located inward of the pair of locking hole parts 54 and the enclosing main body part 62 is coupled to the pair of base end portions 61, the additional enclosing part 60 as a whole is located inward of the pair of locking hole parts 54.

Note that it is not essential for the enclosing main body part 62 to have a U-shape as viewed in the longitudinal direction of the side pieces 40. The enclosing main body part 62 may be continuous with the pair of base end portions 61 at an angle such as a right angle. The enclosing main body part 62 may also have a flat plate shape or V plate shape.

The space enclosed by the cover main body part 52, the pair of base end portions 61, and the cover main body part 52 is the second wire housing space 64 that houses the second wire 24. The second wire housing space 64 is open on both sides in the longitudinal direction of the side pieces 40. The through direction of the second wire housing space 64 coincides with the longitudinal direction of the side pieces 40. The second wire 24 is housed within the second wire housing space 64 in a state of passing therethrough in the longitudinal direction of the side pieces 40. The second wire housing space 64 is partitioned from the first wire housing space 36 by the cover main body part 52.

The first wire 22 is thus housed within the first wire housing space 36, and, separately thereto, the second wire 24 is housed within the second wire housing space 64. The first wire 22 is inhibited from entering the second wire housing space 64 and the second wire 24 is inhibited from entering the first wire housing space 36.

As described above, there are envisaged to be fewer second wires 24 than first wires 22. The second wire housing space 64 may thus be smaller than the first wire housing space 36, as viewed in the longitudinal direction of the first wire 22 and the second wire 24. The smaller number of second wires 24 can thereby be housed inside a smaller space, and the larger number of first wires 22 can be housed inside a larger housing space.

The enclosing main body part 62, which is a portion of the additional enclosing part 60 on the opposite side to the main body component 32 as described above, is formed in an arc shape projecting outward as viewed in the through direction of the second wire housing space 64. The height of a widthwise center portion of the second wire housing space 64 is thus greater than both sides thereof.

The length of the additional enclosing part 60 in the through direction of the second wire housing space 64 is formed so as to gradually decreases proceeding away from the main body component 32. In the present embodiment, the pair of base end portions 61 are formed so as to gradually narrow in width proceeding away from the cover main body part 52. The enclosing main body part 62 is also formed so as to gradually decrease in length proceeding away from the cover main body part 52. Thus, when the additional enclosing part 60 is viewed in the width direction of the cover main body part 52, the additional enclosing part 60 has a trapezoidal shape that gradually narrows in width proceeding away from the cover main body part 52.

When adjacent wire movable path regulating components 30 are rotationally moved in a direction that brings the enclosing main body parts 62 closer together, adjacent enclosing main body parts 62 are thus less likely to interfere with each other. A large rotational movement range can thereby be set for the adjacent wire movable path regulating components 30.

The cover component 50 has regulating shape plane symmetry with respect to a surface orthogonal to the width direction thereof. In other words, the pair of positioning auxiliary protruding parts 53 and the pair of locking hole parts 54 of the cover main body part 52 are formed in a bilaterally symmetrical shape in the width direction. The additional enclosing part 60 is also formed in a bilaterally symmetrical shape. Also, the cover component 50 has regulating shape plane symmetry with respect to a surface orthogonal to the through direction of the second wire housing space 64. In other words, the pair of positioning auxiliary protruding parts 53 and the pair of locking hole parts 54 of the cover main body part 52 are formed in a symmetrical shape in the front-back direction, which is the through direction of the second wire housing space 64. The additional enclosing part 60 is also formed in a symmetrical shape in the front-back direction.

Thus, even if the attachment orientation of the cover component 50 to the main body component 32 is changed left to right, the combined shape of the main body component 32 and the cover component 50 is the same. In other words, two postures are conceivable as attachment postures of the cover component 50 to the main body component 32, based on the combination of the pair of lock protruding parts 48 and the pair of locking hole parts 54. In either posture, the combined shape of the main body component 32 and the cover component 50 is the same.

Note that, here, regulating shape plane symmetry means having plane symmetry in relation to shapes for regulating the path of the wires 22 and 24; that is, the cover component 50 has plane symmetry in relation to functional portions that relate to keeping the first wire 22 and the second wire 24 in the housed state, and regulating the range over which the wire movable path regulating component 30 rotationally moves. Thus, for example, the cover component 50 need also not have plane symmetry in relation to design-related shape portions thereof that do not affect the above functions

### Operations of Path Regulating Wire Harness

Example operations of the path regulating wire harness 20 will now be described.

The path regulating wire harness 20 is arranged so as to extend between the vehicle body main body 10 and the sliding door 14. In this state, the wire movable path regulating component 30 at one end of the plurality of wire movable path regulating components 30 coupled together in a row is coupled to the vehicle body main body 10. The wire movable path regulating component 30 at the other end of the plurality of wire movable path regulating components 30 is coupled to the sliding door 14. The plurality of wire movable path regulating components 30 thereby move so as to bend following the opening and closing operation of the sliding door 14. Between adjacent wire movable path regulating components 30, the pairs of coupling protruding parts 44 are regulated to rotationally moving about the axis thereof. Also, the rotational movement range of adjacent wire movable path regulating components 30 is regulated by the shapes of the first regulating edges 46a and the second regulating edges 46b. The path of the plurality of wire movable path regulating components 30 is thus regulated so as to bend in a bending form determined in advance.

The first wire 22 and the second wire 24 are able to bend while the paths thereof are regulated by the plurality of wire movable path regulating components 30 with opening and closing of the sliding door 14. At this time, the path of the first wire 22 is regulated by the plurality of first wire housing spaces 36 that are arranged successively in a row. The path of the second wire 24 is regulated by the plurality of second wire housing spaces 64 that are arranged successively in a row next to the first wire 22.

Note that the plurality of wire movable path regulating components 30 coupled together in a row may be covered by an exterior member 70 formed in a cylindrical shape and made of rubber or the like (see FIGS. 1 and 5). The exterior member may, for example, be a member also known as a rubber boot.

Supposing that the first wire housing space 36 and the second wire housing space 64 were continuous with each other, the first wire 22 could possibly move to the second wire housing space 64 side, and the second wire 24 could possibly move to the first wire housing space 36 side. In that case, the degree of freedom in the positions of the first wire 22 and the second wire 24 in the wire movable path regulating component 30 increases. This leads to instability such as the first wire 22 being located on the outer peripheral side or the second wire 24 is located on the inner peripheral side, in a state where the path regulating wire harness 20 is bent. As such, the path lengths of the first wire 22 and the second wire 24 could possibly change greatly in response to changes in the path of the path regulating wire harness 20.

In the present embodiment, the path of the first wire 22 is regulated by the first wire housing space 36, and the path of the second wire 24 is regulated by the second wire housing space 64 next to the first wire 22. Therefore, the paths of the first wire 22 and the second wire 24 are regulated in limited areas, compared to the case where the first wire housing space 36 and the second wire housing space 64 are continuous with each other. Changes in the path lengths of the first wire 22 and the second wire 24 due to changes in the path of the path regulating wire harness 20 can thus be reduced.

The required lengths of the first wire 22 and the second wire 24 are thus easy to predict. The ways in which the first wire 22 and the second wire 24 will bend inside the path regulating wire harness 20 are also easy to predict. The bending capacity of the first wire 22 and the second wire 24 is thus easy to predict. Note that the bending capacity can be evaluated by the number of bends or the like until the first wire 22 and the second wire 24 break, in the case where repeated bending is performed under the condition that the path is regulated by the wire movable path regulating components 30.

### Utilization Example

The path regulating wire harness 20 can, for example, be utilized in situations such as the following.

For example, assume that, in the basic design, a path regulating wire harness that includes at least one first wire 22 and does not include a second wire 24 is designed. The basic design is, for example, a design relating to an initial model of a vehicle. In the basic design, an electrical component incorporated into the sliding door 14 is set. As a path regulating wire harness that corresponds to the basic design, path design for regulating bending of the path of the first wire 22 connected to the electrical component incorporated in the sliding door 14 is carried out. This path regulating wire harness employs a wire movable path regulating component that omits the additional enclosing part 60 of the path regulating wire harness 20.

Assume that, thereafter, additional design for adding an electrical component to the sliding door 14 is carried out. In this case, path regulation will be performed with the addition of the second wire 24 that is connected to the additional electrical component. The first wire housing space 36 is designed to regulate the path of the first wire 22 in the basic design. Thus, there could possibly be no space left in the first wire housing space 36 for housing the second wire 24. Also, if the second wire 24 is added to the first wire housing space 36, the behavior of the first wire 22 in the first wire housing space 36 will change, and the bending capacity of the first wire 22 could possibly change.

In view of this, as described above, the cover component 50 to which the additional enclosing part 60 is added is set. The cover component 50 having the additional enclosing part 60 is attached to the main body component 32, instead of the cover component employed in the basic design. The main body component 32 is the same as the main body component 32 in the basic design.

In this case, the path of the first wire 22 is regulated in a similar manner to the basic design. Thus, the bending capacity of the second wire 24 need only be predicted. Since the path of the second wire 24 is regulated within the second wire housing space 64 partitioned from the first wire housing space 36, the bending behavior of the second wire 24 is stable, and there is also little fluctuation in path length following bending. The bending capacity due to addition the second wire 24 can thus be readily predicted.

### Effects and Related Matters

According to the wire movable path regulating component 30 and the path regulating wire harness 20 constituted as described above, even if the second wire 24 is added to a path regulating wire harness that is based on a basic design, the path of the first wire 22 is regulated within the first wire housing space 36 that is based on the basic design. Addition of the second wire 24 is thus unlikely to affect the movement of the first wire 22. Also, the path of the second wire 24 is regulated within the second wire housing space 64 partitioned from the first wire housing space 36. Since the path of the first wire 22 is regulated within the first wire housing space 36 and the path of the second wire 24 is regulated within the second wire housing space 64, the ranges of the first wire 22 and the second wire 24 at the time of changing the paths are limited. Changes in the path lengths of the first wire 22 and the second wire 24 in response to changes in the paths thereof are thus reduced. Variation in the loads acting on the first wire 22 and the second wire 24 when the paths of the first wire 22 and the second wire 24 change is thereby reduced. As a result, the bending capacities of the first wire 22 and the second wire 24 are readily predicted.

Also, because the mold of the main body component 32 for the basic design can be used, it is not necessary to make a new mold. Design is also facilitated because the enclosing part 60 need only be added to the shape of the cover main body part 52 for the basic design.

Also, the second wire 24 can be readily added as long as there are fewer second wires 24 than first wires 22. Also, the movable range of the added second wire 24 at the time of path regulation is limited, as a result of the second wire 24 being housed in the second wire housing space 64, which is smaller than the first wire housing space 36. The bending capacity of the second wire 24 is thereby readily predicted.

Also, since the additional enclosing part 60 is provided inward of the locking hole parts 54, the locking hole parts 54 can be readily molded without the additional enclosing part 60 getting in the way.

Also, since the cover component 50 has regulating shape plane symmetry in both the left-right direction and the front-rear direction, the cover component 50 can be attached to the main body component 32 without worrying about orientation.

Also, the length of the additional enclosing part 60 in the front-back direction is set so as to gradually decrease proceeding away from the main body component 32. When the wire movable path regulating component 30 rotates relative to an adjacent wire movable path regulating component 30, the additional enclosing part 60 is thus unlikely to interfere with the adjacent additional enclosing part 60. It is thus easy to set a large rotational movement range for the adjacent wire movable path regulating components 30.

Also, the portion of the additional enclosing part 60 on the opposite side to the main body component 32 is formed in an arc shape. Thus, when covering the outer side of the plurality of wire movable path regulating components 30 arranged successively in a row with the exterior member 70, the additional enclosing part 60 is unlikely to catch on the exterior member 70, and it is easy to cover the wire movable path regulating components 30 with the exterior member 70. Also, it is easy to maintain the first wire 22 in the widthwise center of the additional enclosing part 60.

Note that the configurations described in the above embodiment and modifications can be combined as appropriate, provided there are no mutual inconsistencies.

1. A wire movable path regulating component for regulating a movable path of at least one first wire and at least one second wire that extend between a first component and a second component movable relative to the first component, the wire movable path regulating component comprising:
a main body configured to be coupled in a rotationally movable manner to another wire movable path regulating component; and
a cover that is a separate component from the main body and is attached to the main body, wherein:
the main body has a housing opening through which the at least one first wire is to be housed and a first wire housing space configured to house the at least one first wire in a state of passing therethrough inside the housing opening,
the cover has a cover main body that blocks the housing opening and an additional enclosing part forming a second wire housing space configured to house the at least one second wire in a state of passing therethrough, and
the second wire housing space is partitioned from the first wire housing space by the cover main body.

2. The wire movable path regulating component according to claim 1, wherein the first wire housing space and the second wire housing space are configured such that the at least one second wire housed within the second wire housing space is fewer in number than the at least one first wire housed within the first wire housing space.

3. The wire movable path regulating component according to claim 1, wherein:
the main body has a locking part located on both side portions of the housing opening,
the cover main body has a lock-receiving part to which the locking part is latched, and
the additional enclosing part is located inward of the lock-receiving part.

4. The wire movable path regulating component according to claim 1, wherein the cover has regulating shape plane symmetry with respect to both a surface orthogonal to a width direction and a surface orthogonal to a through direction of the second wire housing space.

5. The wire movable path regulating component according to claim 1, wherein a length of the additional enclosing part in a through direction of the second wire housing space gradually decreases proceeding away from the main body.

6. The wire movable path regulating component according to claim 1, wherein a portion of the additional enclosing part on an opposite side to the main body is formed in an arc shape as viewed in a through direction of the second wire housing space.

7. A path regulating wire harness comprising:
a plurality of the wire movable path regulating component according to claim 1;
the at least one first wire; and
the at least one second wire, wherein:
the plurality of wire movable path regulating components are coupled together in a row in such a manner as to be rotationally movable relative to each other,
the at least one first wire is housed in the plurality of wire movable path regulating components in a state of passing through the first wire housing space, and
the at least one second wire is housed in the plurality of wire movable path regulating components in a state of passing through the second wire housing space.
